(19) United States
(12) Patent Application Publication
(10) Pub. No.: US 2009/0245991 A1
(43) Pub. Date: Oct. 1, 2009

(54) Transport Trailer and Method

(76) Inventor: Mark Cook, Lufkin, TX (US)

Correspondence Address: LOREN G. HELMREICH, 5851 San Felipe, SUITE 975, HOUSTON, TX, 77057, US

(21) Appl. No.: 12/480,262

(22) Filed: Jun. 8, 2009

Related U.S. Application Data
(63) Continuation-in-part of application No. 11/866,802, filed on Oct. 3, 2007.
Application No. 11/866,802 is a continuation-in-part of application No. 11/581,919, filed on Oct. 17, 2006.

(51) Int. Cl. B62D 63/06; B60P 3/00; B60P 1/00

(52) U.S. Cl. 414/679

(57) ABSTRACT

A trailer 10 includes a frame (12) having a central axis (14) spaced between rear wheels. A plurality of storage supports or bins (20) are supported on the trailer frame, with each storage support supporting a plurality of objects thereon. A carriage assembly (24) rotates the plurality of storage supports. A powered drive (110) rotates the carriage assembly, and a powered brake (112) prohibits rotation of the carriage assembly when power is not applied to the motor. During rotation of the storage supports, a lower portion of a storage support rotates below the rear wheel axis.

### RELATED APPLICATIONS

The present application is a continuation-in-part of U.S. Ser. No. 11/866,802 filed Oct. 5, 2007, which is a continuation-in-part of U.S. Ser. No. 11/581,919 filed Oct. 17, 2006.

### FIELD OF THE INVENTION

The present invention relates to trailers of the type conventionally used for transporting objects, including trailers removably connected to or integral with a powered operator cab. More particularly, this invention relates to an improved trailer for reducing injury to transport personnel. In one embodiment, the trailer may be used to transport various parcels or packages supported in rotatable storage bins.

### BACKGROUND OF THE INVENTION

Various types of trailers have been devised to transport objects, and trailers have been specifically designed for transporting one type of object. Nevertheless, a considerable time and money are incurred in loading and unloading selected ones of the transported objects at a specific location. Moreover, trailer workers are commonly injured when loading and unloading objects from a trailer, particularly when the objects are heavy and/or bulky.

U.S. Pat. No. 6,814,214 discloses a unitary trailer and powered operator cab. The trailer includes a pallet and conveyor system for loading pallets onto the vehicle, with the pallets movable in an elongate loop with front and rear ends of the loop rotating about an axis parallel to the vehicle's axis.

Various types of patents disclose systems for generally transporting tires. U.S. Pat. No. 5,927,931 discloses a lift for raising and lowering a stack of tires. U.S. Pat. Nos. 5,027,991 and 5,356,163 each disclose structures for transporting a single tire. U.S. Pat. No. 6,382,644 discloses a transport and a tire and wheel assembly. A device referred to as the Tire Butler being promoted by Mobile Concepts, Inc. uses a trailer for transporting tires. Publication 2001/0028838 and U.S. Pat. No. 6,527,499 also disclose equipment for handling and transporting tires.

U.S. Pat. No. 5,823,558 discloses a trailer loading support. A load distribution system for trucks is disclosed in U.S. Pat. No. 6,157,889. Publication 2003/0226470 discloses a rail transport system for bulk materials.

The disadvantages of the prior art are overcome by the present invention, and an improved trailer and method are hereinafter disclosed.

### SUMMARY OF THE INVENTION

In one embodiment, a trailer for transporting objects includes a trailer frame having a central axis spaced between left-side and right-side rear wheels, and a plurality of storage units supported on the trailer frame, with each supporting unit for supporting a plurality of objects thereon and having a storage support axis substantially parallel to the trailer frame central axis. A carriage is provided for rotatably supporting the plurality of storage units about a carriage axis substantially parallel with the trailer central axis. A powered carriage rotator is provided for rotating the plurality of supports about a carriage axis. When powered by the carriage rotator, a lower portion of each rotating storage unit is positioned below a central axis of the rear wheels, thereby reducing the height at which parcels may be loaded or unloaded from a storage unit. A brake may be provided for prohibiting rotation of the plurality of supports when power is not applied to the carriage rotator.

These and further features and advantages of the present invention will become apparent from the following detailed description, wherein reference is made to the figures in the accompanying drawings.

### BRIEF DESCRIPTION OF THE DRAWINGS

FIG. 1 is a side view of a suitable trailer and powered operator cab with the side door raised.

FIG. 2 is a rear view of the trailer shown in FIG. 1, with the side doors raised.

FIG. 3 is a top view of the trailer shown in FIG. 1, with the side doors closed and the operator cab removed.

FIG. 4 is a side view of another embodiment of a trailer.

FIG. 5 is a cross-sectional view of the trailer shown in FIG. 4.

FIG. 6 illustrates a preferred mechanism for controllably rotating each support bin when the carriage is rotated.

### DETAILED DESCRIPTION OF PREFERRED EMBODIMENTS

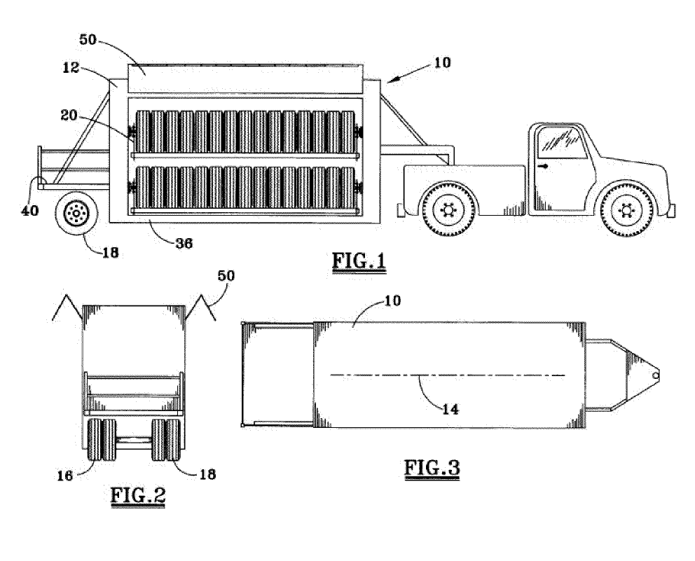

FIG. 1 discloses one embodiment of a trailer 10 for transporting tires. For the depicted embodiment, a powered operator cab may be used to transport the trailer removable from the cab, or the trailer may be integral with the frame of the powered transport cab. In the latter case, the combination of a trailer and a cab is generally referred to as a truck.

The trailer includes a trailer frame 12 having a central axis 14 which, as shown in FIG. 3 is spaced between a left-side rear wheel 16 and a right-side rear wheel 18. As disclosed further below, the trailer frame supports a plurality of storage units 20, which for the embodiment depicted in FIG. 1, is a plurality of tires. Each storage unit has a storage support axis 22 which is substantially parallel to the trailer central axis 14. The carriage assembly 24 rotatably supports the plurality of tires about a carriage axis substantially parallel with the trailer central axis.

For the embodiment as shown in FIG. 1, the entirety of the carriage and the plurality of storage units are forward of the rear wheels of the trailer. A storage deck 40 is provided above the rear wheels for storing miscellaneous objects. As shown in FIG. 1, the low position of the tires relative to the ground is achieved by providing a lower portion 36 of the trailer frame which is vertically below the centerline of the wheels 16, 18. In a preferred embodiment, the trailer frame supports moveable side panels 50, which may be lowered to be flush with the exterior of the frame during transport, as shown in FIG. 3, but may be raised as shown in FIGS. 1 and 2 when the trailer is parked to allow for full viewing of the carriage operation.

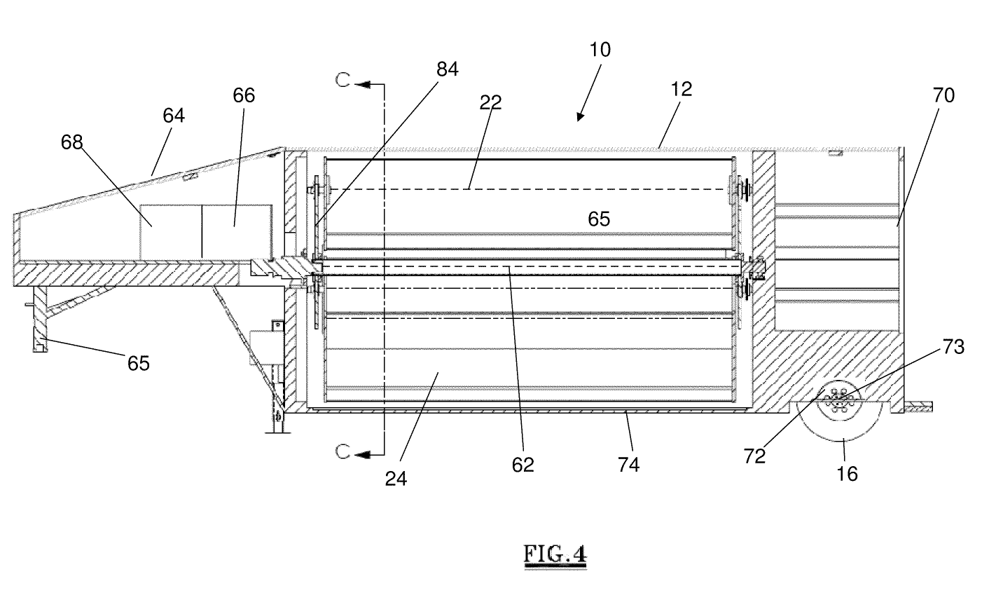

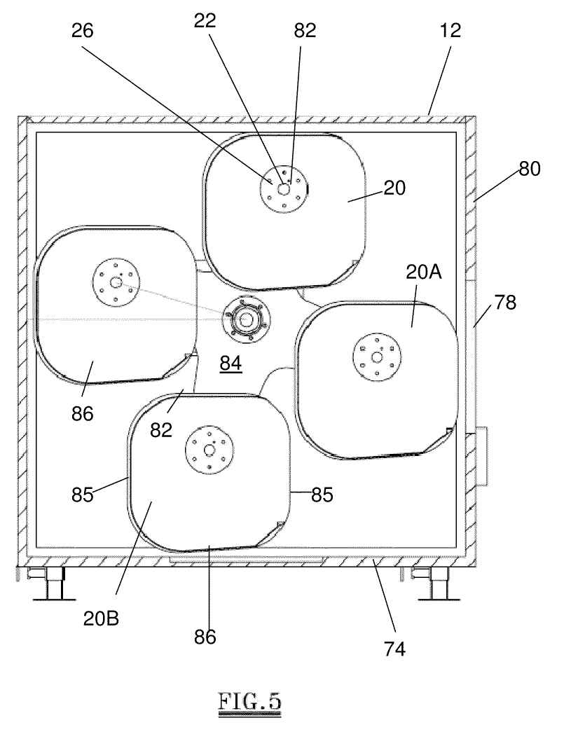

FIG. 4 discloses an alternate embodiment of a trailer 10 with a trailer frame 12 having a central axis spaced equidistant between the left-side rear wheel 16 and an opposing right-side rear wheel. A plurality of storage units 20 each have a storage support axis 22 which is substantially parallel to the trailer central axis. A carriage assembly 24 rotatably supports the plurality of storage units about a central carriage axis 62.

The trailer 10 includes a substantially rectilinear trailer frame which houses the carriage assembly 24. A front portion 64 of the trailer frame is provided for storage and a connector 65 for connection of the frame to a tractor or truck. Inside of the front portion 64 is a drive motor 66 and a powered brake 68. The drive motor 66 rotates the carousel 24 about the central axis 62. When power is not supplied to the drive motor 66, the powered brake 68 provides a lock mechanism for prohibiting rotation of the carriage, i.e., when the trailer is moving down the road. As an alternative to the powered brake mechanism, a manual brake may be used to provide a positive interference with the carriage assembly 24 to prevent rotation of the carriage assembly when moving down the road. A suitable motor/powered brake combination unit is the Model 9 motor or output drive with an A2 Series spring biased brake sold by Auburn Gear, Inc. A rear portion 70 of the trailer frame may be provided for receiving larger, awkward packages.

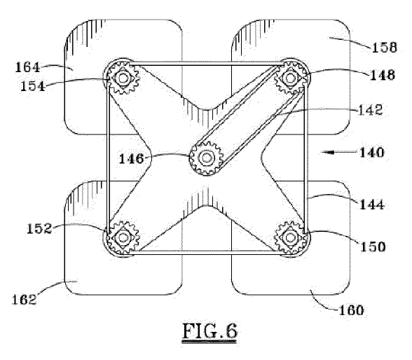

As shown in FIG. 4, a centerline 72 of the axle 73 interconnecting the centers of the rear wheels is positioned above the floor 74 of the frame 12. Moreover, a portion of each bin or storage support 20 includes a lower portion which is rotated below the axle centerline 72 when the drive motor 66 is activated, as explained subsequently. Referring now to FIG. 5, each of the plurality of bins 20 is shown in cross-section with an opening 76 for placing packages within and removing packages from a respective bin when the bin is in the 20A position as shown in FIG. 5, so that the opening 76 in the bin 20 is adjacent the opening 78 in the side 80 of the frame 12. Each bin is rotatably supported on a pivot 26 which rotates about the centerline 22, as discussed above. Front rotatable plate 84 and a similar rear plate may be provided for supporting a plurality of bins. Note in FIG. 5 that as the powered drive 66 rotates the carriage assembly 24, a lower portion 86 of each bin, e.g., bin 20B, passes closely adjacent the floor 74 of the trailer frame, and more specifically passes below a centerline 72 of the rear axle. This feature results in bin 20A as shown in FIG. 5 being at a relatively low level for loading and unloading packages from the bin compared to alternative designs wherein the entirety of the bins rotated at a position above the axle 72, thereby either reducing the cross-sectional size of each bin and/or increasing the height at which packages may be reliably loaded and unloaded from a bin 20.

Referring still to FIG. 5, it should be understood that the cross-sectional area of the bins compared to the interior cross-sectional area within the trailer 12 is very high. Each bin as shown in FIG. 5 may have a cross-sectional area of from 6 ft² to 8.5 ft², so that the total cross-sectional bin area is from 24 ft² to 34 ft². The cross-sectional area of the container 12 is approximately 63 ft². Accordingly, the total cross-sectional area of the bins is at least 38% of the interior cross-sectional area of the trailer, and preferably is at least 42% of the trailer interior cross-sectional area. This percentage is high considering that the carousel rotates the bins entirely within the trailer frame, and is in part attributed to the substantially rectangular design of each bin and the arrangement discussed below for maintaining each bin orientation as the carousel is rotated.

As shown in FIG. 5, each of the bins has a substantially rectangular cross-sectional configuration, with a top, bottom, side, and bin opening 76. Although the configuration of the bins may vary, providing bins with a substantially rectilinear cross-sectional configuration increases the volume available for receiving packages in a bin while maintaining the trailer frame 12 of a reasonable size, and most importantly not creating interference between different bins or components when the carriage assembly is rotated.

It is a particular feature of the invention that each of the bins 20 rotate in unison when the carriage assembly 24 is rotated, so that the bottom floor 86 of each bin is at the same position relative to its respective axis 22 when the assembly is rotated. The feature which moves the bins in unison and maintains a desired orientation of each bin also preferably controls the inadvertent “rocking” of a bin, so a bin does not undesirably rock or rotate about its axis when the carriage assembly is not rotated, i.e., when the trailer is in transit.

Referring now to FIG. 6, the drive assembly 140 includes a sprocket 146 which rotates about axis 62 shown in FIG. 4, and a drive chain 142 which rotates sprocket 148, which is functionally connected to pivot 26. Sprocket 148 in turn is interconnected with each of sprockets 154, 152, and 150 by chain 144, so that each of bins 162, 164, 158, and 160 maintain a desired orientation when the carriage is rotating, and lock each bin in the desired position when the carriage is not rotating.

Various controls may be provided at desired locations on the trailer, including the sides of the trailer where objects are loaded and unloaded onto and from the storage units, and at the rear of the trailer near a power unit. These controls, if desired, may rotate the carousel in either a clockwise or a counterclockwise direction. Safety circuits may be used to ensure that the carousel is not rotated until raised to a sufficient level so that the carousel can rotate without hitting the lower frame of the trailer.

The storage supports as disclosed herein comprise a plurality of racks which are free to rotate with respect to the carriage end plates. In most applications, three or more racks may be equally spaced circumferentially about the carriage. A significant feature of the carriage assembly is that it allows the operator to load or unload goods from either the driver's side of the trailer or the passenger side of the trailer. In some applications, the right-side of the trailer may be blocked, yet the operator may easily and safely unload goods from the left-side of the trailer. At the next delivery spot, the operator has the flexibility of unloading from the left-side of the trailer when the right-side of the trailer is blocked.

The trailer may have only one side door, or a side door and a rear door. In yet other embodiments, two or more side doors may be provided on either side of the trailer and/or additional rear doors may be provided, depending on the goods to be transported and the configuration of the racks.

The trailer as disclosed herein may be used for transporting various objects. Bottles of water may be transported in a similar manner to tires, and oils or other liquids may be transported in drums or boxes. A conventional shelf or tray rather than space rods may be used to support a plurality of boxes between the end plates, and such a support tray would be suitable for transporting vehicular batteries, package delivery boxes, and various products distributed to retail food stores, including produce, dairy products, cookies/crackers, bread, and potato chips. A tray or bin may extend between the end plates replacing the purpose of the rods 42, 44 used to support tires. The tray or bin 20 preferably having a base or floor 86, top 82, and sides 85. The bin 20 may be suitably supported to hold to the weight of the goods between the end plates 62.

The term “trailer” as used herein refers to a trailer removably connected to a powered operator cab, whether termed a tractor, a truck, or a cab, and includes fifth wheel trailers and gooseneck trailers. A “trailer” also includes the trailer portion of cab/trailer combinations, whether detachable from the cab or integral with the cab. A conventional utility truck for delivery of parcels or bread is thus considered to include a trailer which is fixed to rather than removable from the cab. The trailer of the present invention offers the ability to sort various products for delivery or pickup, to load the goods curbside on either side of the trailer, and to handle heavy objects without significant lifting. A refrigerated trailer may be used for transporting dairy products, meat, or seafood.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A trailer for transporting objects, comprising:
a trailer frame having a central axis spaced between a left-side rear wheel and a right-side rear wheel, a center of the left-side wheel and a center of the right-side wheel defining a rear axle axis;
the trailer frame including a side door for opening to access an interior of the trailer frame;
a plurality of storage bins supported on the trailer chassis, each storage bin sized for supporting a plurality of objects thereon, each storage bin having a bin support axis substantially parallel to the trailer frame central axis;
a powered carriage rotator for rotating the plurality of bins about a carriage axis fixed with respect to the trailer frame; and
each storage bin having a lower portion which rotates below the rear axle axis when the powered carriage rotator rotates the plurality of bins, thereby reducing the height of a bin when adjacent the side door.

2. A trailer as defined in claim 1, wherein the lower portion of the trailer frame is below the rear axle axis.

3. A trailer as defined in claim 1, wherein each bin includes a pivot for rotating the bin with respect to the carriage axis.

4. A trailer as defined in claim 1, further comprising:
a brake for prohibiting rotation of the plurality of bins about the carriage axis when power is not applied to the carriage rotator.

5. A trailer as defined in claim 1, wherein each bin has a generally rectangular cross-sectional configuration.

6. A trailer as defined in claim 1, wherein each bin has a lower substantially planar plate which is maintained in a generally horizontal position as the plurality of bins rotate about the carriage axis.

7. A trailer as defined in claim 1, wherein a chain and sprocket mechanism rotates each of the plurality of bins to rotate in unison when the powered carriage rotator rotates the plurality of bins, such that an orientation of each bin with respect to a vertical plane remains substantially constant.

8. A trailer as defined in claim 1, wherein the plurality of bins are each spaced axially forward of the rear axle axis.

9. A trailer for transporting objects, comprising:
a trailer frame having a central axis spaced between a left-side rear wheel and a right-side rear wheel, a center of the left-side wheel and a center of the right-side wheel defining a rear axle axis;
the trailer frame including a side door for opening to access an interior of the trailer frame;
a plurality of storage bins supported on the trailer chassis, each storage bin sized for supporting a plurality of objects thereon, each storage bin rotatable about a bin support axis substantially parallel to the trailer frame central axis;
a powered carriage rotator for rotating the plurality of bins about a carriage axis fixed with respect to the trailer frame;
a chain and sprocket mechanism for rotating each of the plurality of bins to rotate in unison when the powered carriage rotator rotates the plurality of bins, such that an orientation of each bin with respect to a vertical plane remains substantially constant; and
each storage bin having a lower portion which rotates below the rear axle axis when the powered carriage rotator rotates the plurality of bins, thereby reducing the height of a bin when adjacent the side door.

10. A trailer as defined in claim 9, wherein the lower portion of the trailer frame is below the rear axle axis.

11. A trailer as defined in claim 9, further comprising:
a brake for prohibiting rotation of the plurality of bins about the carriage axis when power is not applied to the carriage rotator.

12. A trailer as defined in claim 9, wherein each bin has a generally rectangular cross-sectional configuration.

13. A trailer as defined in claim 9, wherein each bin has a lower substantially planar plate which is maintained in a generally horizontal position as the plurality of bins rotate about the carriage axis.

14. A trailer as defined in claim 9, wherein the plurality of bins are each spaced axially forward of the rear axle axis.

15. A trailer for transporting objects, comprising:
a trailer frame having a central axis spaced between a left-side rear wheel and a right-side rear wheel, a center of the left-side wheel and a center of the right-side wheel defining a rear axle axis;
the trailer frame including a side door for opening to access an interior of the trailer frame;
a plurality of storage bins supported on the trailer chassis, each storage bin sized for supporting a plurality of objects thereon, each storage bin rotatable about a bin support axis substantially parallel to the trailer frame central axis;
a powered carriage rotator for rotating the plurality of bins about a carriage axis fixed with respect to the trailer frame;
a brake mechanism for prohibiting rotation of the plurality of bins about the carriage axis when the trailer is moving; and
each storage bin having a lower portion which rotates below the rear axle axis when the powered carriage rotator rotates the plurality of bins, thereby reducing the height of a bin when adjacent the side door.

16. A trailer as defined in claim 15, wherein the lower portion of the trailer frame is below the rear axle axis.

17. A trailer as defined in claim 15, wherein each bin has a generally rectangular cross-sectional configuration.

18. A trailer as defined in claim 15, wherein each bin has a lower substantially planar plate which is maintained in a generally horizontal position as the plurality of bins rotate about the carriage axis.

19. A trailer as defined in claim 15, wherein a chain and sprocket mechanism rotates each of the plurality of bins to rotate in unison when the powered carriage rotator rotates the plurality of bins, such that an orientation of each bin with respect to a vertical plane remains substantially constant.

20. A trailer as defined in claim 15, wherein the plurality of bins are each spaced axially forward of the rear axle axis.
